(19) United States
(12) Patent Application Publication
(10) Pub. No.: US 2026/0145059 A1
(43) Pub. Date: May 28, 2026

(54) COMPUTER-IMPLEMENTED METHOD, GAME SYSTEM, AND ONE OR MORE NON-TRANSITORY COMPUTER-READABLE STORAGE MEDIA HAVING STORED THEREIN GAME PROGRAM

(71) Applicant: NINTENDO CO., LTD., Kyoto (JP)

(72) Inventor: Takuya KOBAYASHI, Kyoto (JP)

(21) Appl. No.: 19/354,998

(22) Filed: Oct. 10, 2025

(30) Foreign Application Priority Data
Nov. 26, 2024 (JP) 2024-205463

(51) Int. Cl. A63F 13/24; A63F 13/213; A63F 13/55

(52) U.S. Cl. CPC A63F 13/24; A63F 13/213; A63F 13/55

(57) ABSTRACT

From a first controller held by one hand of a user and having a first mouse sensor and a first stick operated by the user, at least one of first mouse sensor data based on an output of the first mouse sensor or first stick data based on an operation on the first stick is acquired. From a second controller held by another hand of the user and having a second mouse sensor and a second stick operated by the user, at least one of second mouse sensor data based on an output of the second mouse sensor or second stick data based on an operation on the second stick is acquired. A first virtual object is moved based on the first stick data, and a second virtual object is moved within a first range from the first virtual object, based on the second mouse sensor data.

### CROSS REFERENCE TO RELATED APPLICATION

This application claims priority to Japanese Patent Application No. 2024-205463 filed on November 26, 2024, the entire contents of which are incorporated herein by reference.

### FIELD

The present disclosure relates to novel game processing.

### BACKGROUND AND SUMMARY

Conventionally, game controllers have been known.

There is room in providing novel game processing to a user.

In view of the above circumstances, configuration examples will be shown below.

### Configuration 1

A configuration 1 is a computer-implemented method comprising: acquiring, from a first controller configured to be held by one hand of a user and having a first mouse sensor and a first stick configured to be operated by the user, at least one of first mouse sensor data based on an output of the first mouse sensor or first stick data based on an operation on the first stick; acquiring, from a second controller configured to be held by another hand of the user and having a second mouse sensor and a second stick configured to be operated by the user, at least one of second mouse sensor data based on an output of the second mouse sensor or second stick data based on an operation on the second stick; moving a first virtual object, based on the first stick data; and moving a second virtual object, within a first range from the first virtual object, based on the second mouse sensor data.

### Configuration 2

In a configuration 2 based on the above configuration 1, the computer-implemented method may comprise, when the second virtual object and a third virtual object are in a first positional relationship, executing first processing in which one of the second virtual object and the third virtual object exerts a first action on the other.

### Configuration 3

In a configuration 3 based on the above configuration 2, the computer-implemented method may comprise, when the second virtual object and the third virtual object are in the first positional relationship, executing, as the first processing, processing in which the second virtual object retains the third virtual object, based on button operation data which is based on an operation on a first button provided to the second controller.

### Configuration 4

In a configuration 4 based on the above configuration 2 or 3, the computer-implemented method may comprise, when the first virtual object and the third virtual object are in a first positional relationship, executing second processing in which one of the first virtual object and the third virtual object exerts a first action on the other.

### Configuration 5

In a configuration 5 based on any one of the above configurations 1 to 4, the computer-implemented method may comprise moving a fourth virtual object, within a second range from the first virtual object, based on the first mouse sensor data.

### Configuration 6

In a configuration 6 based on the above configuration 5, the first controller may have the first stick, and a first set of plural buttons or direction input buttons, at a front part, and may have the first mouse sensor at a side part. The second controller may have the second stick, and a second set of plural buttons or direction input buttons, at a front part, and may have the second mouse sensor at a side part. In the first controller, the first stick may be located upward of the first set of plural buttons or direction input buttons, and in the second controller, the second set of plural buttons or direction input buttons may be located upward of the second stick.

### Configuration 7

In a configuration 7 based on the above configuration 6, the computer-implemented game processing method may comprise: when a third virtual object and one of the second virtual object or the fourth virtual object are in a first positional relationship, causing the one of the second virtual object or the fourth virtual object to retain the third virtual object; and when the one and the other of the second virtual object or the fourth virtual object are in a first positional relationship or when the third virtual object and the other of the second virtual object or the fourth virtual object are in a first positional relationship, executing processing of exerting a first action on the third virtual object.

### Configuration 8

In a configuration 8 based on any one of the above configurations 1 to 7, the computer-implemented game processing method may comprise: moving the second virtual object, at a certain height, based on the second mouse sensor data; and changing a height of the second virtual object, based on the second stick data or button operation data which is based on an operation on a first button provided to the second controller.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the main body apparatus 2, and the left controller 3 and the right controller 4, are used separately from each other;

FIG. 3 is six orthogonal views showing a non-limiting example of the left controller 3;

FIG. 4 is six orthogonal views showing a non-limiting example of the right controller 4;

FIG. 5 is a block diagram showing a non-limiting example of the internal configuration of the main body apparatus 2;

FIG. 6 is a block diagram showing a non-limiting example of the internal configurations of the main body apparatus 2, the left controller 3, and the right controller 4;

FIG. 7 shows a non-limiting example of an operation manner for the controllers in a first exemplary embodiment;

FIG. 8 shows a non-limiting example of a game screen in the first exemplary embodiment;

FIG. 9 shows a non-limiting example of a game screen in the first exemplary embodiment;

FIG. 10 shows a non-limiting example of a game screen in the first exemplary embodiment;

FIG. 11 shows a non-limiting example of a game screen in the first exemplary embodiment;

FIG. 12 shows a non-limiting example of various data stored in a DRAM 85 of the main body apparatus 2;

FIG. 13 shows a non-limiting example of the data structure of operation data 608;

FIG. 14 is a non-limiting example of a flowchart showing the details of game processing according to the first exemplary embodiment;

FIG. 15 is a non-limiting example of a flowchart showing the details of a right arm control process;

FIG. 16 shows a non-limiting example of an operation manner for controllers in a second exemplary embodiment;

FIG. 17 shows a non-limiting example of a game screen in the second exemplary embodiment;

FIG. 18 shows a non-limiting example of a game screen in the second exemplary embodiment;

FIG. 19 shows a non-limiting example of a game screen in the second exemplary embodiment;

FIG. 20 is a non-limiting example of a flowchart showing the details of game processing according to the second exemplary embodiment;

FIG. 21 is a flowchart showing the details of a left arm control process.

### DETAILED DESCRIPTION OF NON-LIMITING EXAMPLE EMBODIMENTS

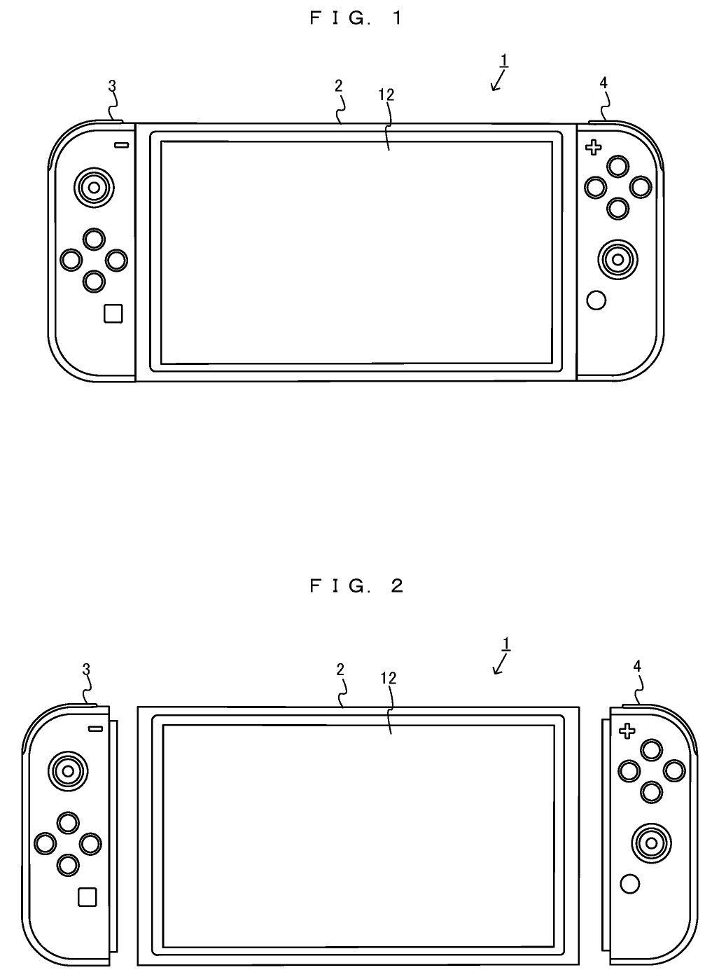

Hereinafter, an exemplary embodiment will be described. FIG. 1 shows an example of an outer appearance of a game system according to the exemplary embodiment. An example of a game system 1 according to the exemplary embodiment includes a main body apparatus (an information processing apparatus, which functions as a game apparatus main body in the exemplary embodiment) 2 which is an example of a computer, a left controller 3, and a right controller 4. Each of the left controller 3 and the right controller 4 is attachable to and detachable from the main body apparatus 2. That is, as shown in FIG. 1, the game system 1 can be used as a unified apparatus obtained by attaching each of the left controller 3 and the right controller 4 to the main body apparatus 2. Further, as shown in FIG. 2, in the game system 1, the main body apparatus 2, the left controller 3, and the right controller 4 can also be used as separate bodies. Hereinafter, the left controller 3 and the right controller 4 may be collectively referred to as "controllers".

The main body apparatus 2 includes a display 12. The display 12 displays an image generated by the main body apparatus 2. The display 12 is a liquid crystal display (LCD), for example.

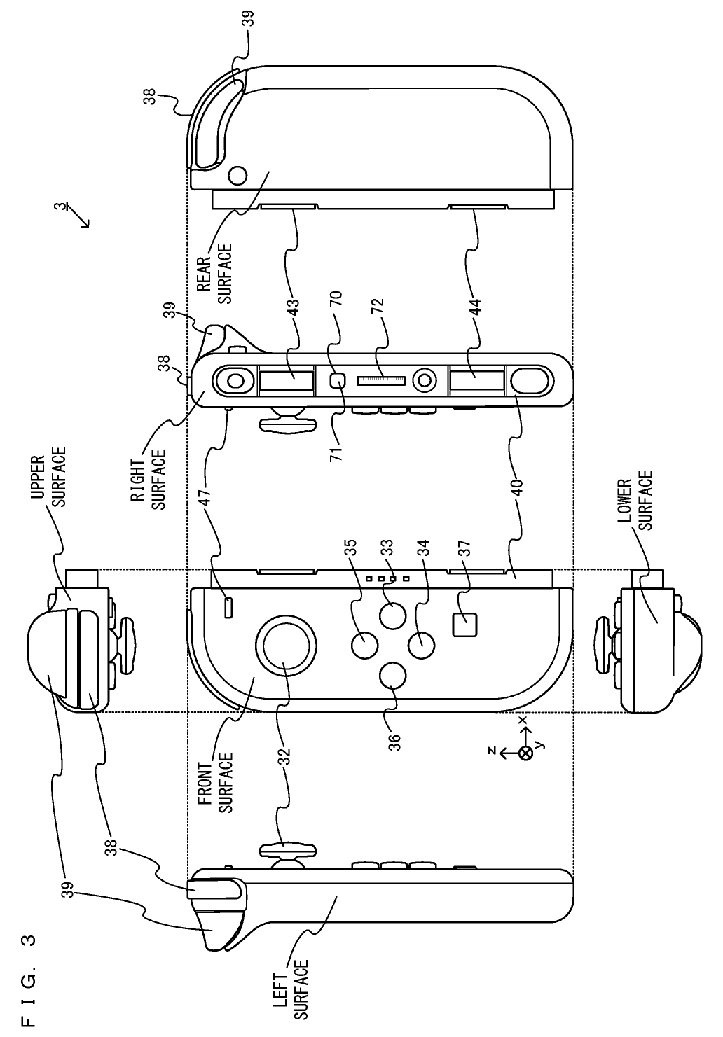

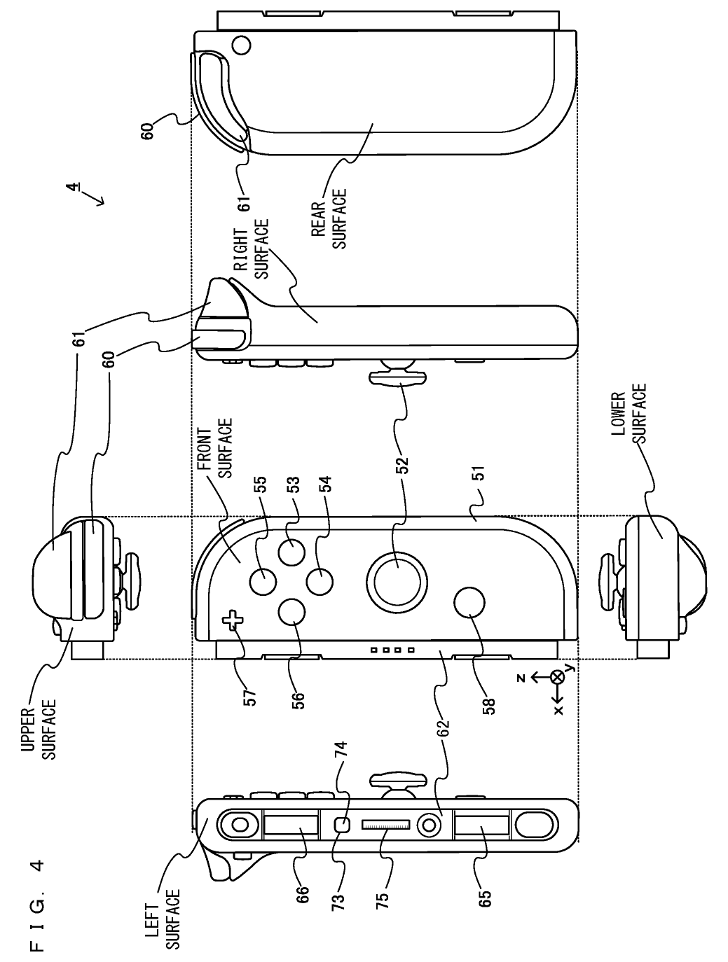

Next, the controllers will be described. FIG. 3 is six orthogonal views showing an example of the left controller 3. As shown in FIG. 3, the left controller 3 has a vertically long shape, i.e., a shape long in a z-axis direction shown in FIG. 3. The left controller 3 has a protruding portion 40 to be fitted into a recessed portion (not shown) of the main body apparatus 2, in a state of being attached to the main body apparatus 2. In the state in which the left controller 3 is detached from the main body apparatus 2, the left controller 3 can also be held in the orientation in which the left controller 3 is vertically long. The left controller 3 has such a shape and a size that, when held in the orientation in which the left controller 3 is vertically long, the left controller 3 can be held with one hand, particularly, the left hand. Further, the left controller 3 can also be held in the orientation in which the left controller 3 is horizontally long, and when held in the orientation in which the left controller 3 is horizontally long, the left controller 3 may be held with both hands.

The left controller 3 has a left analog stick (may be referred to as a "left stick") 32 as an example of a direction input device. As shown in FIG. 3, the left stick 32 is provided on a front surface of the left controller 3. The left stick 32 can be used as a direction input section with which a direction can be inputted. By tilting the left stick 32, the user can input a direction corresponding to the tilt direction and can input a magnitude corresponding to the angle of the tilt.

The left controller 3 has various operation buttons. The left controller 3 has a right direction button 33, a down direction button 34, an up direction button 35, a left direction button 36, a record button 37, and a "−" (minus) button 47, at the front surface. The left controller 3 has an L button 38 and a ZL button 39 over a range from the upper surface to the left surface. The L button 38 and the ZL button 39 may be provided at only the upper surface of the left controller 3, or may be provided only at the left surface of the left controller 3. The left controller 3 has a button 43 and a button 44 at the protruding portion 40 on the right surface.

The left controller 3 has a mouse sensor opening 70 at the protruding portion 40 on the right surface. The mouse sensor opening 70 is an opening through which light is guided to the mouse sensor 71 provided inside. The mouse sensor 71 is a general mouse sensor (e.g., an optical-type or laser-type mouse sensor), for example, and acquires data for calculating movement (movement direction, movement distance, movement speed, etc.), on a working surface, of the left controller 3 placed with the right surface (i.e., the upper surface of the protruding portion 40) facing the working surface.

The left controller 3 has, at the protruding portion 40 on the right surface, a terminal 72 for the left controller 3 to perform wired communication with the main body apparatus 2.

FIG. 4 is six orthogonal views showing an example of the right controller 4. As shown in FIG. 4, the right controller 4 has a vertically long shape, i.e., a shape long in a z-axis direction shown in FIG. 4. The right controller 4 has a protruding portion 62 to be fitted into a recessed portion (not shown) of the main body apparatus 2, in a state of being attached to the main body apparatus 2. In the state in which the right controller 4 is detached from the main body apparatus 2, the right controller 4 can also be held in the orientation in which the right controller 4 is vertically long. The right controller 4 has such a shape and a size that, when held in the orientation in which the right controller 4 is vertically long, the right controller 4 can be held with one hand, particularly, the right hand. Further, the right controller 4 can also be held in the orientation in which the right controller 4 is horizontally long, and when held in the orientation in which the right controller 4 is horizontally long, the right controller 4 may be held with both hands.

The right controller 4 has a right analog stick (may be referred to as "right stick") 52 as a direction input section, at the front surface. In the exemplary embodiment, the right stick 52 has the same configuration as the left stick 32 of the left controller 3. The right controller 4 has various operation buttons. The right controller 4 has an A button 53, a B button 54, an X button 55, a Y button 56, a "+" (plus) button 57, and a home button 58 at the front surface. The right controller 4 has an R button 60 and a ZR button 61 over a range from the upper surface to the right surface. The R button 60 and the ZR button 61 may be provided at only the upper surface of the right controller 4. The right controller 4 has a button 65 and a button 66 at the protruding portion 62 on the left surface.

The right controller 4 has a mouse sensor opening 73 at the protruding portion 62 on the left surface. The mouse sensor opening 73 is an opening through which light is guided to a mouse sensor 74 provided inside. The mouse sensor 74 is a general mouse sensor (e.g., an optical-type or laser-type mouse sensor), for example, and acquires data for calculating movement (movement direction, movement distance, movement speed, etc.), on a working surface, of the right controller 4 placed with the left surface (i.e., the upper surface of the protruding portion 62) facing the working surface.

The right controller 4 has, at the protruding portion 62 on the left surface, a terminal 75 for the right controller 4 to perform wired communication with the main body apparatus 2.

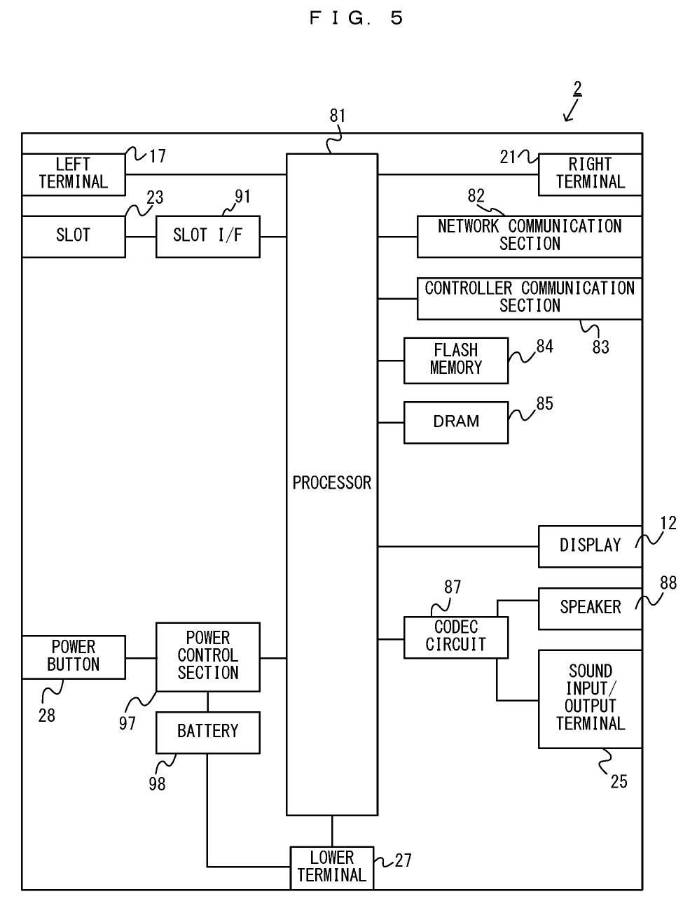

FIG. 5 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to a slot 23, or the like), thereby executing the various types of information processing.

The main body apparatus 2 includes the flash memory 84 and a DRAM (Dynamic Random Access Memory) 85 as examples of internal storage media. The flash memory 84 is a memory mainly used to store various data (or programs) to be saved in the main body apparatus 2. The DRAM 85 is a memory used to temporarily store various data used for information processing. The processor 81 appropriately reads and writes data from and to storage media such as the flash memory 84 and the DRAM 85, thereby executing various information processes.

The main body apparatus 2 includes various components, as shown in FIG. 5. These will be briefly described below. A slot interface (may be referred to as "slot I/F") 91 performs reading/writing of data from/into a predetermined kind of storage medium (e.g., a dedicated memory card) attached to the slot 23, in accordance with an instruction from the processor 81. A network communication section 82 performs communication (e.g., Internet communication) with an external device via a network.

The controller communication section 83 performs wireless communication (e.g., communication compliant with the standard of Bluetooth (registered trademark)) with the left controller 3 and/or the right controller 4. A left terminal 17 is a terminal for performing data communication between the processor 81 and the left controller 3. A right terminal 21 is a terminal for performing data communication between the processor 81 and the right controller 4. A lower terminal 27 is a terminal for outputting data (e.g., image data and sound data) to a stationary monitor or the like via a cradle when the lower terminal 27 is attached to the cradle.

The display 12 displays an image generated by the processor 81 and/or an image acquired from the outside. A codec circuit 87 controls input and output of sound data to and from the speaker 88 and the sound input/output terminal 25. A power control section 97 controls supply of power from a battery 98 to each section of the main body apparatus 2 (i.e., each of sections to be supplied with power from the battery 98), based on an instruction from the processor 81, and starts or stops supply of power in response to pressing of a power button 28.

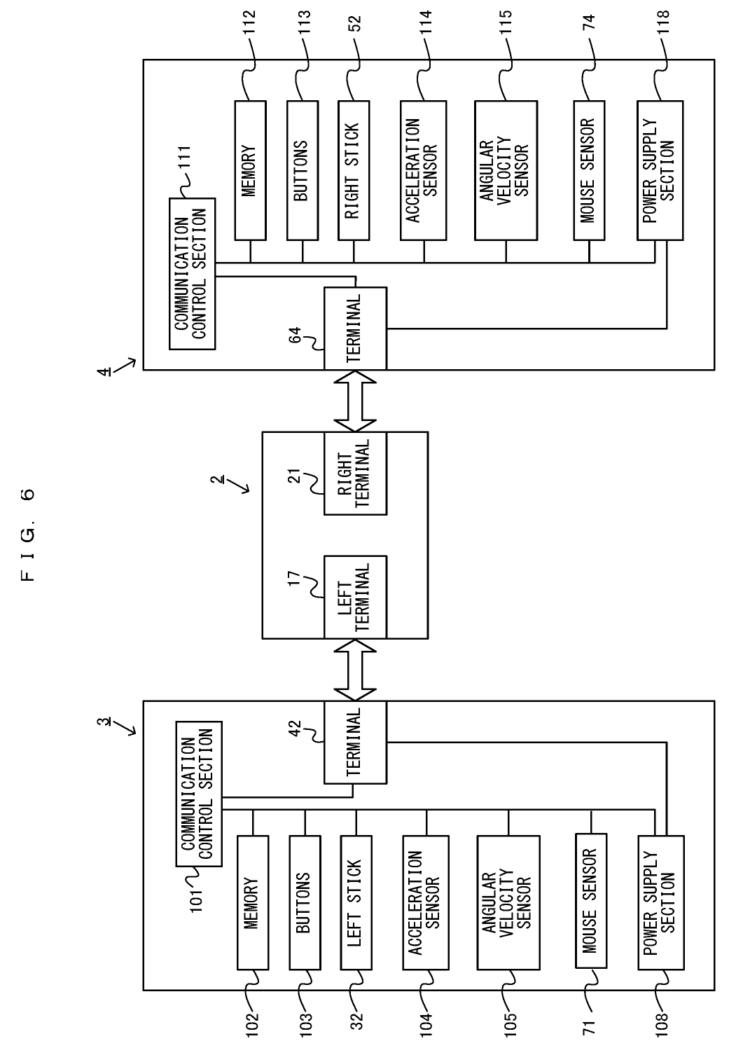

FIG. 6 is a block diagram showing examples of the internal configurations of the main body apparatus 2, the left controller 3, and the right controller 4. The details of the internal configuration of the main body apparatus 2 are shown in FIG. 5 and therefore are omitted in FIG. 6.

The left controller 3 includes a communication control section 101 which performs communication with the main body apparatus 2. As shown in FIG. 6, the communication control section 101 is connected to various components including a terminal 42. In a state in which the left controller 3 is attached to the main body apparatus 2, the communication control section 101 performs communication with the main body apparatus 2 via the terminal 42, and in a state in which the left controller 3 is detached from the main body apparatus 2, the communication control section 101 performs wireless communication with the main body apparatus 2.

The left controller 3 includes a memory 102 such as a flash memory. The communication control section 101 includes, for example, a microcomputer (or a microprocessor) and executes firmware stored in the memory 102, thereby executing various processes.

The left controller 3 has buttons 103 (right direction button 33, down direction button 34, up direction button 35, left direction button 36, L button 38, ZL button 39, etc.) and the left stick 32. Each of the buttons 103 and the left stick 32 outputs information regarding an operation performed on itself to the communication control section 101 repeatedly at appropriate timings.

The left controller 3 has the mouse sensor 71. The mouse sensor 71 acquires data for calculating movement (movement direction, movement distance, movement speed, etc.) of the left controller 3 on a working surface. The data acquired by the mouse sensor 71 is outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104, 105, and 71). The communication control section 101 transmits operation data including the acquired information or information obtained by performing predetermined processing on the acquired information, to the main body apparatus 2. The operation data is transmitted repeatedly, once every predetermined time.

The above operation data is transmitted to the main body apparatus 2, whereby the main body apparatus 2 can obtain inputs provided to the left controller 3. That is, the main body apparatus 2 can determine operations performed on the buttons 103 and the left stick 32, based on the operation data. Further, the main body apparatus 2 can calculate information regarding at least one of the motion or the orientation of the left controller 3 based on the operation data (specifically, the detection results of the acceleration sensor 104 and the angular velocity sensor 105). The main body apparatus 2 can calculate information about a mouse operation performed on the left controller 3, based on operation data (specifically, a detection result from the mouse sensor 71). Various kinds of determinations regarding the state of the left controller 3 may be executed. For example, the main body apparatus 2 may execute determination as to whether or not the mouse sensor opening 70 is in a state of contacting with the working surface or a state close to a state of contacting with the working surface, based on corresponding data transmitted from the communication control section 101. Such calculation and determination may be executed by system software of the main body apparatus 2, may be executed by a game application, or may be executed by a controller, for example.

The left controller 3 includes a power supply section 108. The power supply section 108 includes a battery and a power control circuit. The power control circuit is connected to the battery and also connected to components of the left controller 3 (specifically, components that receive power supplied from the battery).

As shown in FIG. 6, the right controller 4 includes a communication control section 111 which performs communication with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls communication performed by the right controller 4 with the main body apparatus 2.

The right controller 4 has input sections similar to those of the left controller 3. Specifically, the right controller 4 has buttons 113 (A button 53, B button 54, X button 55, Y button 56, R button 60, ZR button 61, etc.), the right stick 52, and the mouse sensor 74. These input sections may have the same functions as those of the left controller 3, and may operate in the same manner.

### First Exemplary Embodiment

Next, a first exemplary embodiment will be described. In the first exemplary embodiment, it is assumed that a game is played in a state in which the main body apparatus 2 alone, from which the left controller 3 and the right controller 4 are detached, is attached to the cradle and the main body apparatus 2 outputs a game image to a stationary monitor or the like via the cradle, as an example.

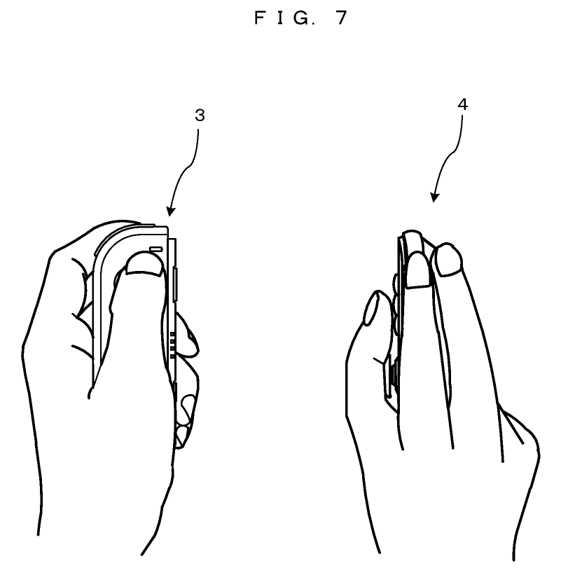

First, an operation method for the controllers assumed in the first exemplary embodiment will be described. FIG. 7 is a schematic view showing the operation method for the controllers assumed in the first exemplary embodiment. As shown in FIG. 7, the left hand holds and operates the left controller 3. The right hand performs an operation in a state in which the right controller 4 is placed such that the surface where the mouse sensor opening is present is in contact with the working surface, and the right hand is put on the right surface of the right controller 4. That is, the right controller 4 is operated as a mouse. Hereinafter, the operation method by the holding way using the left hand as shown in FIG. 7 is referred to as a controller operation, and the operation method using the right hand as shown in FIG. 7 is referred to as a mouse operation. In the following description, for convenience of explanation, a mouse operation by the left controller 3 may be referred to as a "left mouse operation" and a mouse operation by the right controller 4 may be referred to as a "right mouse operation", so as to discriminate mouse operations for the left and right controllers from each other.

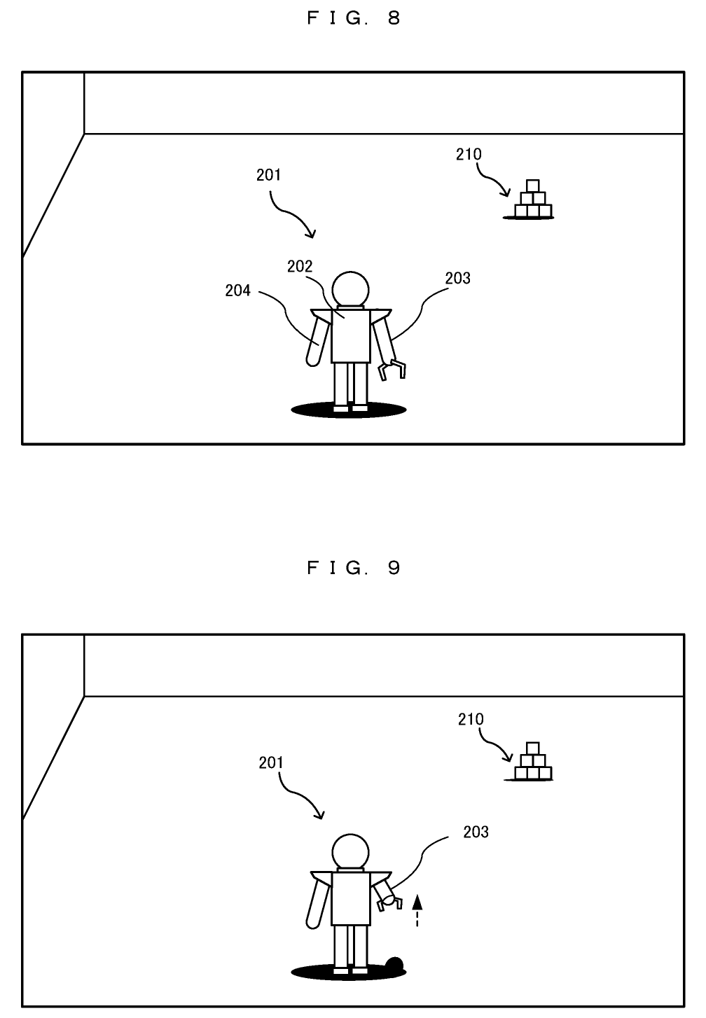

Next, the outline of a game assumed in the first exemplary embodiment will be described. The game assumed in the first exemplary embodiment is a game in which a player object (hereinafter, referred to as PO) which is a robot is operated to carry a block in a virtual space. FIG. 8 shows a game screen according to the first exemplary embodiment. In FIG. 8, the PO 201 and a plurality of block objects (hereinafter, simply referred to as blocks) 210 placed in a virtual three-dimensional space are displayed. The PO 201 is composed of a body object (hereinafter, simply referred to as body) 202, a right arm object (hereinafter, simply referred to as right arm) 203, and a left arm object (hereinafter, simply referred to as a left arm) 204. A claw is provided to a distal end part of the right arm 203.

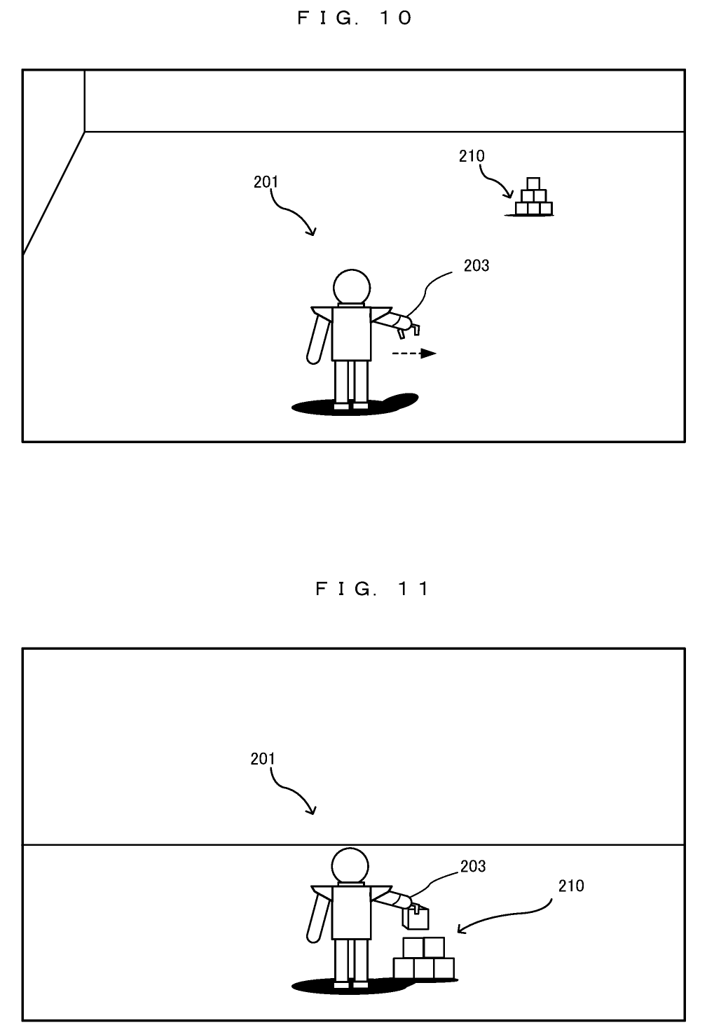

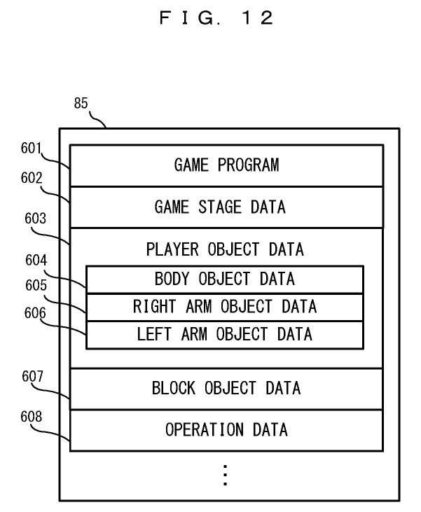

Next, an operation example in this game will be described. In this game, the body 202 can be moved in the virtual space by the left stick 32. Along with movement of the body 202, the right arm 203 and the left arm 204 move integrally. Hereinafter, integral movement of the body 202, the right arm 203, and the left arm 204 is regarded as "movement of the PO 201". That is, in this game, the PO 201 can be moved by the left stick 32. By an operation of moving the right controller 4 on the working surface (hereinafter, right mouse movement operation), only the right arm 203 can be moved in a predetermined range based on a right shoulder part of the PO 201. For example, FIG. 9 shows a state in which the right arm 203 is extended frontward by the right controller 4 being moved frontward on the working surface. FIG. 10 shows a state in which the extended right arm 203 is moved in the right direction by the right controller 4 being moved in the right direction on the working surface. Then, when the right arm 203 and the block 210 are in a predetermined positional relationship, an action of grasping the block 210 can be performed by pressing the R button 60 (hereinafter, referred to as R click). For example, the PO 201 is moved to a position close to the block 210 through an operation on the left stick 32, the distal end of the right arm 203 is moved close to the block 210 through a right mouse operation, and then the R button 60 is pressed. Thus, as shown in FIG. 11, an action of grasping one of the stacked blocks 210 is performed. The action of grasping the block 210 (hereinafter, a grasping action) is an action in which the claw part at the distal end of the right arm 203 descends and grasps the block 210 and then rises to the original position, for example. The state of grasping the block 210 can be released by performing R click again in a state of grasping the block 210, for example. Specifically, an action in which the claw part descends and puts the grasped block 210 and then rises again is performed (hereinafter, grasp releasing action). Therefore, the user operates the left stick 32 in a state of grasping the block 210, to move the PO 201 to a predetermined position set as a destination to which the block 210 is to be carried, and then performs R click, whereby the user can place the block 210 at the position.

The above operation method for the grasping action is merely an example. As another example, control may be performed such that, while the R button 60 is being pressed, a grasping state is continued, and when a finger is taken off the R button 60, a grasp releasing action is performed.

### Used Data Example

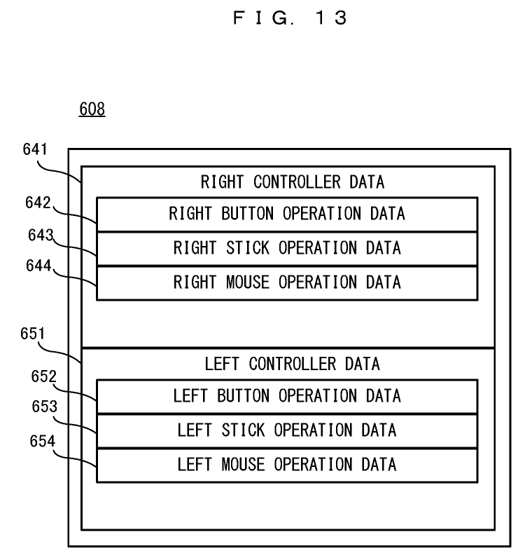

Next, various data used in processing in the first exemplary embodiment will be described. FIG. 12 is a memory map showing an example of various data stored in the DRAM 85 of the main body apparatus 2. In the DRAM 85, a game program 601, game stage data 602, player object data 603, block object data 607, operation data 608, and the like are stored.

The game program 601 is a program for executing the game processing.

The game stage data 602 is data defining the configuration of a game stage. For example, terrains of the game stage, placement positions of blocks, and the like are defined.

The player object data 603 is data about the PO 201. The player object data 603 includes body object data 604, right arm object data 605, and left arm object data 606. The body object data 604 is data about the body 202, and includes data indicating the present position and the orientation, and the like. The right arm object data 605 is data about the right arm 203, and includes various data indicating the position, the orientation, and the present state (whether or not the right arm 203 is performing a grasping action, etc.) of the right arm 203. The left arm object data 606 is data about the left arm 204, and includes various data indicating the position, the orientation, and the present state of the left arm 204.

The block object data 607 is data about the block 210. The block object data 607 includes data indicating the outer appearance of the block 210 and various data indicating the present position, the orientation, and the present state (whether or not the block is grasped, etc.) of each of a plurality of blocks 210 that are present.

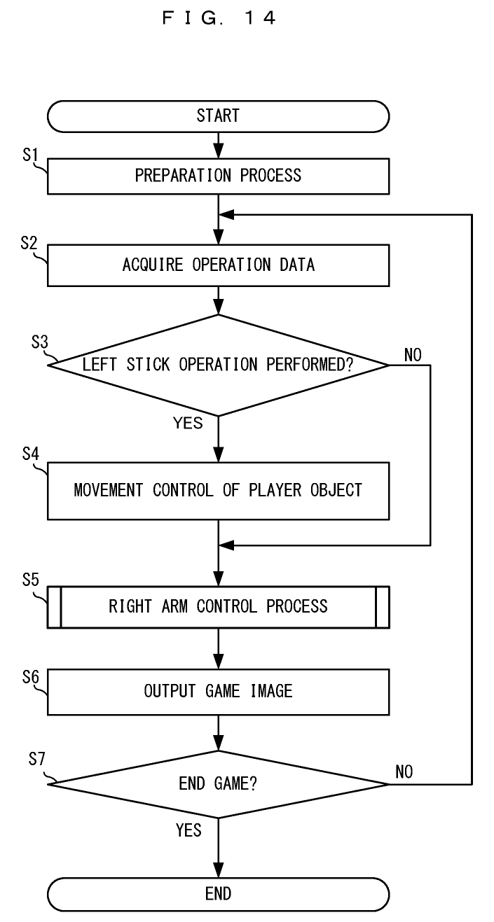

The operation data 608 is data indicating the contents of operations performed on the controllers. FIG. 13 shows an example of the data structure of the operation data 608. The operation data 608 includes right controller data 641 and left controller data 651.

The right controller data 641 includes right button operation data 642, right stick operation data 643, and right mouse operation data 644. The right button operation data 642 is data indicating the press state of each button 113 of the right controller 4. The right stick operation data 643 is data indicating the input direction, the input amount, and the like of the right stick 52. The right mouse operation data 644 is data indicating a detection result from the mouse sensor 74 of the right controller 4. The right mouse operation data 644 may be data indicating movement amounts in an x-axis direction and a y-axis direction, or position coordinates (x, y) on a virtual mouse plane, for example.

The left controller data 651 includes left button operation data 652, left stick operation data 653, and left mouse operation data 654. The left button operation data 652 is data indicating the press state of each button 103 of the left controller 3. The left stick operation data 653 is data indicating the input direction, the input amount, and the like of the left stick 32. The left mouse operation data 654 is data indicating a detection result from the mouse sensor 71 of the left controller 3.

### Flowchart Example

Next, examples of flowcharts of the game processing according to the first exemplary embodiment will be described. In this example, one or more processors read and execute programs stored in one or more memories, whereby the flowcharts described below are implemented. The flowcharts are merely examples of processing procedures. Therefore, the processing order of steps may be changed as long as the same result is obtained. In addition, values of variables and thresholds used in determination steps are also merely examples, and other values may be employed as necessary.

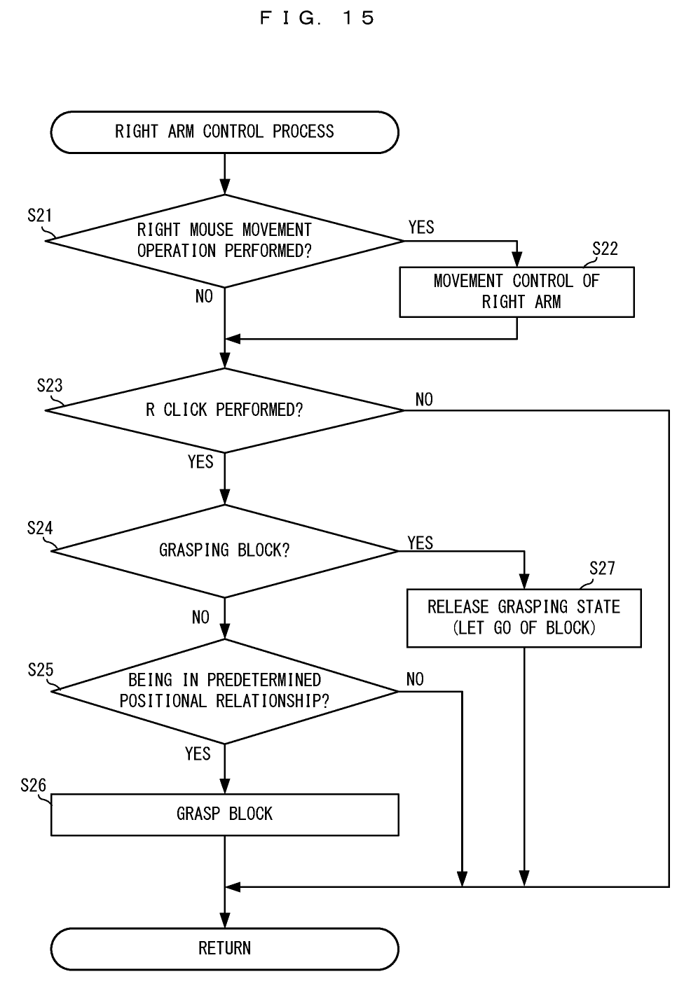

FIG. 14 is a flowchart showing the details of an example of the game processing according to the first exemplary embodiment. A processing loop from step S1 to step S7 in FIG. 14 is repeated a plurality of times in one second in accordance with the frame rate.

When the game processing is started, first, a preparation process is executed (step S1). In this process, processing of constructing a virtual space as shown in FIG. 8 and placing the PO 201 and the blocks 210 at predetermined positions defined as initial placement positions, is executed. Then, an image obtained by a virtual camera capturing the virtual space is outputted as a game image, and game play is started. Then, the process proceeds to step S2.

Next, the operation data 608 is acquired (step S2). Next, whether or not any operation on the left stick 32 (hereinafter, left stick operation) is being performed is determined based on the operation data 608 (step S3). As a result of the determination, if a left stick operation is being performed (YES in step S3), movement control of the PO 201 is performed based on the content of the operation on the left stick 32. That is, processing of moving the body 202 based on the left stick operation data 653 and integrally moving the right arm 203 and the left arm 204 along with the movement of the body 202 is performed. On the other hand, if a left stick operation is not being performed (NO in step S3), the process in step S4 is skipped.

Next, a right arm control process is executed (step S5). FIG. 15 is a flowchart showing the details of the right arm control process. In FIG. 15, first, whether or not a right mouse movement operation has been performed is determined based on the operation data 608 (step S21). As a result of the determination, if a right mouse movement operation has been performed (YES in step S21), movement control of the right arm 203 is performed based on the right mouse operation data 644 (step S22). On the other hand, if a right mouse movement operation has not been performed (NO in step S21), the process in step S22 is skipped.

Next, whether or not R click has been performed is determined (step S23). If R click has not been performed (NO in step S23), the right arm control process is ended. On the other hand, if R click has been performed (YES in step S23), next, whether or not the grasping action is not being performed and the block 210 is grasped by the right arm 203 at present, is determined (step S24). If the block 210 is not grasped (NO in step S24), next, whether or not the right arm 203 (specifically, the distal end part of the right arm 203) and the block 210 are in a predetermined positional relationship is determined (step S25). For example, whether or not they are in such a positional relationship that a distance between the distal end of the right arm 203 and any block 210 is equal to or smaller than a predetermined distance, is determined. As a result of the determination, if they are not in the predetermined positional relationship (NO in step S25), the right arm control process is ended. On the other hand, if they are in the predetermined positional relationship (YES in step S25), control for a grasping action as described above is started targeting the block 210 present at a position closest to the distal end of the right arm (step S26). Then, the right arm control process is ended.

On the other hand, as a result of the determination in step S24, if the block 210 is grasped (YES in step S24), control for the grasp releasing action is started (step S27). Then, the right arm control process is ended.

Returning to FIG. 14, next, a game image in which the results of the above processes have been reflected is generated and outputted (step S6).

Next, whether or not a condition for ending the game processing is satisfied is determined (step S7). If the condition is not satisfied (NO in step S7), the process returns to step S1 and the process is repeated. If the condition is satisfied (YES in step S7), the game processing is ended.

As described above, in the first exemplary embodiment, the PO 201 is moved by the left stick 32 and the right arm 203 is moved through a right mouse operation, to perform an action of grasping the block 210. Thus, in a configuration in which separate controllers are respectively operated by left and right hands, a novel game in which an operation by an analog stick and a mouse operation are used in combination can be provided. In particular, a movement operation that can greatly change a position in the virtual space is performed through a stick operation, and fine position control such as position adjustment for grasping the block 210 as described above is performed through a mouse movement operation, whereby intuitive and favorable operability can be provided. For example, in a case of attempting to fix the position of the right arm 203 at a certain position, if the position of the right arm 203 is operated by the right stick 52, an operation of keeping a tilted state of the right stick 52 at a certain angle is required. As compared to such an operation, performing movement control through a right mouse operation makes it easier to fix the right arm 203 at an intended position and grasp the block more accurately.

In the exemplary embodiment, the information processing apparatus 2 acquires the left mouse operation data 654 but does not use the left mouse operation data 654 in the game processing. That is, even though the left controller 3 has a device that is the mouse sensor 71, the device is not used in the game processing. The same applies to the right stick 52 of the right controller 4. As described above, while each game controller has a plurality of devices suitable for a movement operation and the information processing apparatus 2 acquires corresponding operation data, only appropriate data for the game processing among the operation data is used, whereby operability for the user can be improved. In the exemplary embodiment, the right stick 52 may be used in the game processing.

### Second Exemplary Embodiment

Next, a second exemplary embodiment will be described. In the first exemplary embodiment, the example in which the right arm 203 of the PO 201 is operated by the right controller 4 has been shown, whereas, in the second exemplary embodiment, a game in which the left arm 204 is also operated in addition to the right arm 203 is assumed.

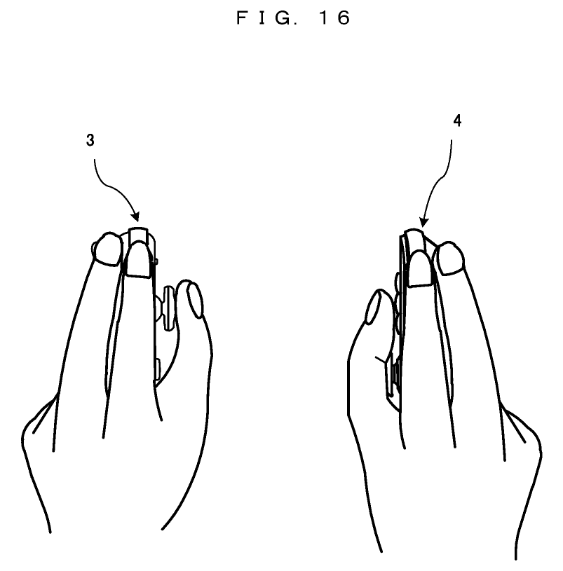

First, an operation method for the controllers assumed in the second exemplary embodiment will be described. FIG. 16 shows an example of an operation method assumed in the second exemplary embodiment. As shown in FIG. 16, in the second exemplary embodiment, mouse operations are performed by both of the left and right controllers. The left stick 32 is operated in this form with the thumb of the left hand put on the left stick 32. In the game according to the second exemplary embodiment, the right stick 52 is not used, but in another exemplary embodiment, a game in which the right stick 52 is also used may be adopted.

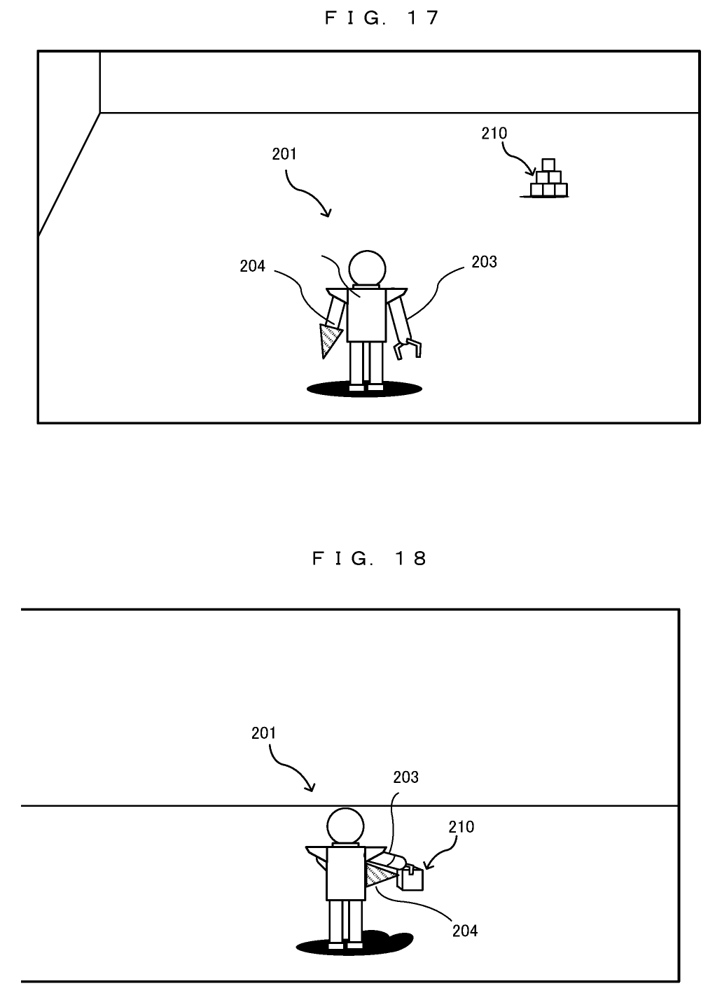

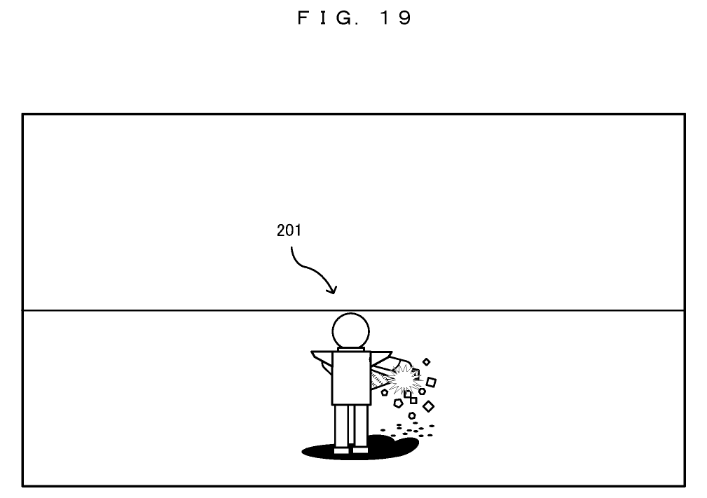

Next, a screen example of the game assumed in the second exemplary embodiment is shown in FIG. 17. In the second exemplary embodiment, the distal end of the left arm 204 of the PO 201 is formed to be a drill. In the game assumed in the second exemplary embodiment, as shown in FIG. 18 and FIG. 19, a block is grasped by the right arm 203, and the block is broken by the drill of the left arm 204.

Next, operations in the second exemplary embodiment will be described. In the second exemplary embodiment, as in the first exemplary embodiment, the PO 201 can be moved by the left stick 32. A grasping action for the block 210 through a right mouse operation can be performed in the same manner as in the first exemplary embodiment. In addition to such operations, in the second exemplary embodiment, the left arm 204 can be moved in a predetermined range based on a left shoulder part of the PO 201 by an operation of moving the left controller 3 on the working surface (hereinafter, left mouse movement operation). Then, in a state in which the block 210 is grasped by the right arm 203, when the drill part at the distal end of the left arm 204 is moved close to the block, the drill is automatically driven to break the block 210. When the breakage is finished or the distance between the drill and the block becomes equal to or greater than a certain distance, driving of the drill is automatically stopped.

Next, the details of the game processing according to the second exemplary embodiment will be described. First, data used in the processing in the second exemplary embodiment are basically the same as in the first exemplary embodiment (see FIG. 12). Therefore, although the detailed description is omitted, the left arm object data 606 includes data such as information indicating the driving state of the drill, needed in accordance with the game contents as described above, as appropriate. Also, the block object data 607 includes information indicating whether or not each block 210 is broken, and the like, as appropriate.

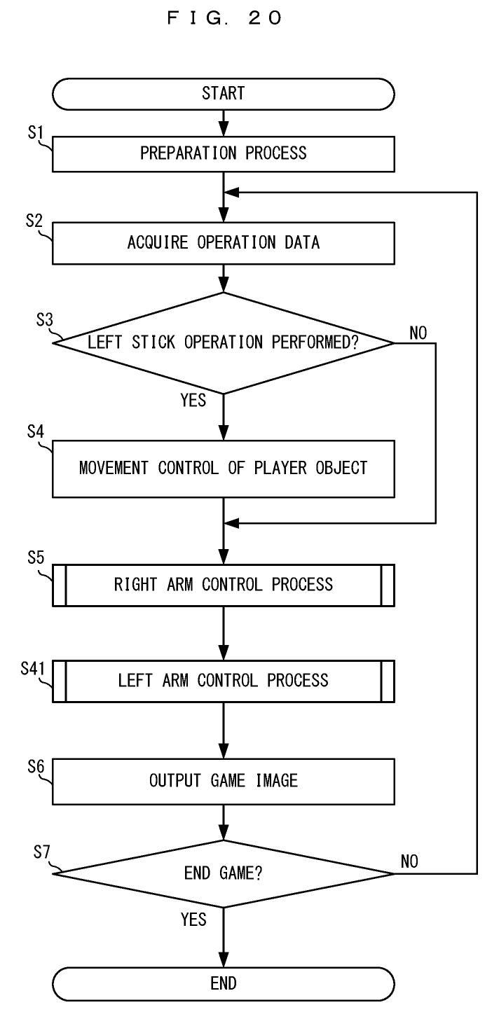

Next, an example of a flowchart of the game processing according to the second exemplary embodiment will be described. FIG. 20 is a flowchart showing the details of an example of the game processing according to the second exemplary embodiment. Here, in the flowchart shown in FIG. 20, the same process as in the flowchart shown in FIG. 14 described in the first exemplary embodiment is executed except for a "left arm control process" in step S41. Therefore, here, only processes relevant to step S41 will be described, and the description of the details of the other processes is omitted.

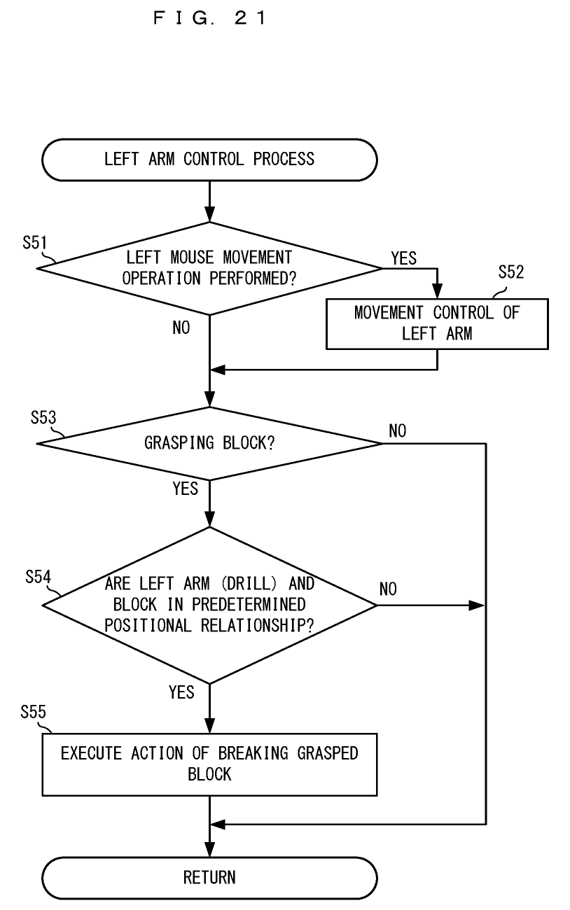

In FIG. 20, subsequent to the process in step S5, the left arm control process is executed (step S41). FIG. 21 is a flowchart showing the details of the left arm control process. In FIG. 21, first, whether or not a left mouse movement operation has been performed is determined based on the operation data 608 (step S51). As a result of the determination, if a left mouse movement operation has been performed (YES in step S51), movement control for the left arm 204 is performed based on the left mouse operation data 654 (step S52). On the other hand, if a left mouse movement operation has not been performed (NO in step S51), the process in step S52 is skipped.

Next, whether or not a block is grasped by the right arm 203 at present is determined (step S53). If a block is not grasped (NO in step S53), the left arm control process is ended. On the other hand, if a block is grasped (YES in step S53), next, whether or not the left arm 204 (specifically, a distal end part of the left arm 204) and the block 210 grasped by the right arm 203 are in a predetermined positional relationship is determined (step S54). For example, whether or not a distance between the distal end of the left arm 204 and the block 210 grasped by the right arm 203 is equal to or smaller than a predetermined distance is determined. As a result of the determination, if they are not in the predetermined positional relationship (NO in step S54), the left arm control process is ended. On the other hand, if they are in the predetermined positional relationship (YES in step S54), an action of breaking the block 210 grasped by the right arm 203 is executed (step S55). Then, the left arm control process is ended.

Regarding the determination in step S54, in another exemplary embodiment, whether or not the left arm 204 and the right arm 203 (which is in a grasping state) are in a predetermined positional relationship may be determined.

Then, returning to FIG. 20, the subsequent processes from step S6 described above are executed. Thus, the description of the example of the flowchart according to the second exemplary embodiment has been finished.

As described above, in the second exemplary embodiment, a novel game in which an analog stick and left and right mouse operations are used in combination can be provided. Here, focusing on the positions of the analog sticks of the left and right controllers in this example, the left controller 3 has the L button 38 at an upper part (shoulder part) of the left controller 3 and has the left stick 32 and the buttons 33 to 36 at the front surface, as shown in FIG. 3. The left stick 32 is provided at a position upward of the buttons 33 to 36. On the other hand, the right controller 4 has the right stick 52 and the buttons 53 to 56 at the front surface, and the positions of the buttons 53 to 56 are upward of the right stick 52. In a case of performing a mouse operation of each of the left and right controllers, the surface where the mouse sensor opening is present is set downward, and an index finger or a middle finger is put on the upper part (the position where the L/R button is present) of the controller. In this case, the thumb is also located on a comparatively upward side. Therefore, in performing a movement operation for the PO 201, using the left controller 3 which has the analog stick at the upper part can improve operability for movement of the PO 201 (as compared to a case of operating the right stick 52).

### Modifications

The game processing in the first exemplary embodiment and the game processing in the second exemplary embodiment may be respectively applied in different games, or may be applied in different scenes in one game. In the latter case, for example, the PO 201 to be operated may be automatically or manually switched among a plurality of POs 201, or the PO 201 to be operated may differ depending on the stage.

In the above exemplary embodiments, the robot having two arms, i.e., left and right arms, has been shown as an example of the PO 201. However, the number of arms is not limited, and the PO 201 may be a virtual object having only one arm, for example.

Actions of an arm and a body need not be clearly distinguished from each other. For example, the body may change in the orientation or the shape along with movement of the arm. Also in such a case, in a player object, a principal part moved through a right mouse operation can be regarded as an arm object, and a principal part moved through a left stick operation can be regarded as a body object.

The PO 201 is not limited to a virtual object resembling a human shape as described above, and may be a virtual object of an animal or a virtual object of a vehicle, for example.

In the above exemplary embodiments, the right arm 203 is shown as an example of an operation target of a right mouse operation. However, an operation target of a right mouse operation is not limited thereto, and may be a weapon object or a viscous object extending from the body in accordance with a right mouse operation, for example.

In the above exemplary embodiments, the example in which the movable range of the right arm 203 is a predetermined range based on a right shoulder of the PO 201 has been shown. However, setting of the movable range is not limited. In another exemplary embodiment, the movable range may be the inside range of a circle or a sphere having a predetermined size centered at the body 202, or the right arm 203 may be movable only on the circumference of a circle having a predetermined size centered at the body 202, for example. The movable ranges of the right arm 203 and the left arm 204 in the second exemplary embodiment may be set to be different ranges or the same range in another exemplary embodiment.

In the above exemplary embodiments, when the right arm 203 and the block 210 are in a predetermined positional relationship, processing of "grasping" is executed. That is, processing in which the right arm 203 and the block 210 act on each other has been shown. Such action processing is not limited to "grasping" or "breaking" as in the second exemplary embodiment, and may be processing of executing another action. For example, the right arm 203 may have a collision detection area so as to push the block 201 or another object or so that the right arm 203 or the PO 201 cannot move further from collision. Besides, processing of "flipping", processing of "burning", processing of "pushing aside", or the like may be performed. In another exemplary embodiment, processing of "attacking", processing of "coloring", processing of "preying", processing of "opening", processing of "absorbing", or the like, may be performed in accordance with an object corresponding to the right arm. In another exemplary embodiment, processing of causing any action between the body 202 and the block 210, instead of between the right arm 203 and the block 210, may be executed. For example, the above processing of "grasping" may be defined as an example of first processing, and separately from the first processing, second processing may be executed when the body 202 and the block 210 are in a predetermined positional relationship. As an example of the second processing, processing of damaging the body 202 or pushing the block 210 may be performed when the body 202 and the block 210 collide with each other. The right arm 203 and/or the body 202 may be unable to act on another object. As an example, the above processing may be applied in a game in which the position or the like of the body 202 or the right arm 202 is operated to capture an image of the present state.

Regarding an operation using the right controller 4, the right stick 52 is not used in the above game example. However, the above processing may be applied to a game in which the right stick 52 is also used in combination. For example, movement control for the right arm 203 may be performed such that the right arm 203 is moved in the horizontal direction at a certain height through a right mouse operation and the right arm 203 is moved in the vertical direction through an operation of the right stick 52. Besides, control of moving the right arm 203 in the vertical direction may be performed based on an operation of the A button 53, the B button 54, the X button 55, or the Y button 56, instead of the right stick 52.

In the above exemplary embodiments, the game in which the block 210 is carried or broken has been shown as an example. However, the game content is not limited to the above example. For example, the above processing may be applied to an action game of FPS (First-person shooter) or TPS (Third-person shooter), a music game, or a puzzle game. As a matter of course, an application target is not limited to a 3D game, and may be a 2D game based on an overhead viewpoint or a looking-down viewpoint, for example. Besides, the above processing may be applied to a game in which one user operates two player characters at the same time. For example, it is assumed that a character A is an operation target of the left controller 3 and a character B is an operation target of the right controller 4. Then, the character A is a main character and is subjected to movement control based on an operation of the left stick 32. The character B is a character that can move only in a predetermined range from the character A, and can be summoned as needed, for example. Further, the character B can be finely controlled for its movement destination by performing movement control or the like through a right mouse operation, and the character B can be easily controlled to stay at a predetermined position.

In another exemplary embodiment, the main body apparatus 2 may be an information processing apparatus such as a smartphone, a tablet terminal, a personal computer, or a wearable terminal. The main body apparatus 2 may be configured without having the display 12. The processor 81 may be a general-purpose processor or a dedicated processor, and may be any type such as an SoC, a CPU, an ASIC, or a microcomputer.

The configurations of the controllers described above are merely an example, and the shapes thereof are not limited to the above shapes and may be other shapes. The controllers may be controllers that are not attachable and detachable to and from the main body apparatus 2. The types and the numbers of the input sections are not limited to the above ones. For example, only one of the controllers may have only either the buttons or the direction input section. The controllers are not limited to one set of two controllers.

In the above exemplary embodiments, the case where the above processing is executed by a single information processing apparatus 2 has been described. The information processing apparatus 2 may include a plurality of storages and processors. Then, the above processing may be executed while being shared by these components. The information processing apparatus may be a server, and the above processing may be executed in a distributed system composed of a plurality of information processing apparatuses including at least one server.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A computer-implemented method comprising:
acquiring, from a first controller configured to be held by one hand of a user and having a first mouse sensor and a first stick configured to be operated by the user, at least one of first mouse sensor data based on an output of the first mouse sensor or first stick data based on an operation on the first stick;
acquiring, from a second controller configured to be held by another hand of the user and having a second mouse sensor and a second stick configured to be operated by the user, at least one of second mouse sensor data based on an output of the second mouse sensor or second stick data based on an operation on the second stick;
moving a first virtual object, based on the first stick data; and
moving a second virtual object, within a first range from the first virtual object, based on the second mouse sensor data.

2. The computer-implemented method according to claim 1, comprising:
when the second virtual object and a third virtual object are in a first positional relationship, executing first processing in which one of the second virtual object and the third virtual object exerts a first action on the other.

3. The computer-implemented method according to claim 2, comprising:
when the second virtual object and the third virtual object are in the first positional relationship, executing, as the first processing, processing in which the second virtual object retains the third virtual object, based on button operation data which is based on an operation on a first button provided to the second controller.

4. The computer-implemented method according to claim 2, comprising:
when the first virtual object and the third virtual object are in a first positional relationship, executing second processing in which one of the first virtual object and the third virtual object exerts a first action on the other.

5. The computer-implemented method according to claim 1, comprising:
moving a fourth virtual object, within a second range from the first virtual object, based on the first mouse sensor data.

6. The computer-implemented method according to claim 5, wherein
the first controller has the first stick, and a first set of plural buttons or direction input buttons, at a front part, and has the first mouse sensor at a side part,
the second controller has the second stick, and a second set of plural buttons or direction input buttons, at a front part, and has the second mouse sensor at a side part,
in the first controller, the first stick is located upward of the first set of plural buttons or direction input buttons, and
in the second controller, the second set of plural buttons or direction input buttons is located upward of the second stick.

7. The computer-implemented method according to claim 5, comprising:
when a third virtual object and one of the second virtual object or the fourth virtual object are in a first positional relationship, causing the one of the second virtual object or the fourth virtual object to retain the third virtual object; and
when the one and the other of the second virtual object or the fourth virtual object are in a first positional relationship or when the third virtual object and the other of the second virtual object or the fourth virtual object are in a first positional relationship, executing processing of exerting a first action on the third virtual object.

8. The computer-implemented method according to claim 1, comprising:
moving the second virtual object, at a certain height, based on the second mouse sensor data; and
changing a height of the second virtual object, based on the second stick data or button operation data which is based on an operation on a first button provided to the second controller.

9. A system comprising:
a first controller configured to be held by a user, the first controller comprising a first mouse sensor, a first stick configured to be operated by the user, and a first transmitter configured to transmit first data including first stick data and first mouse sensor data based on an output from the first controller;
a second controller configured to be held by the user, the second controller comprising a second mouse sensor, a second stick configured to be operated by the user, and a second transmitter configured to transmit second data including second stick data and second mouse sensor data based on an output from the second controller; and
a device comprising a receiver, one or more processors, and one or more non-transitory computer-readable storage media having stored therein which, when executed by the one or more processors, cause the device to execute game processing,
the game processing comprising:
moving a first virtual object, based on the first stick data included in the first data received by the receiver, and
moving a second virtual object, within a first range from the first virtual object, based on the second mouse sensor data included in the second data received by the receiver.

10. The game system according to claim 9, the game processing comprising:
when the second virtual object and a third virtual object are in a first positional relationship, executing first processing in which one of the second virtual object and the third virtual object exerts a first action on the other.

11. The game system according to claim 10, the game processing comprising:
when the second virtual object and the third virtual object are in the first positional relationship, executing, as the first processing, processing in which the second virtual object retains the third virtual object, based on button operation data which is based on an operation on a first button provided to the second controller.

12. The game system according to claim 10, the game processing comprising:
when the first virtual object and the third virtual object are in a first positional relationship, executing second processing in which one of the first virtual object and the third virtual object exerts a first action on the other.

13. One or more non-transitory computer-readable storage media having stored therein instructions which, when executed by one or more processors, cause a computer to execute game processing, the game processing comprising:
acquiring, from a first controller configured to be held by one hand of a user and having a first mouse sensor and a first stick configured to be operated by the user, at least one of first mouse sensor data based on an output of the first mouse sensor or first stick data based on an operation on the first stick;
acquiring, from a second controller configured to be held by another hand of the user and having a second mouse sensor and a second stick configured to be operated by the user, at least one of second mouse sensor data based on an output of the second mouse sensor or second stick data based on an operation on the second stick;
moving a first virtual object, based on the first stick data; and
moving a second virtual object, within a first range from the first virtual object, based on the second mouse sensor data.

14. The one or more non-transitory computer-readable storage media according to claim 13, the game processing comprising:
when the second virtual object and a third virtual object are in a first positional relationship, executing first processing in which one of the second virtual object and the third virtual object exerts a first action on the other.

15. The one or more non-transitory computer-readable storage media according to claim 14, the game processing comprising:
when the second virtual object and the third virtual object are in the first positional relationship, executing, as the first processing, processing in which the second virtual object retains the third virtual object, based on button operation data which is based on an operation on a first button provided to the second controller.

16. The one or more non-transitory computer-readable storage media according to claim 14, the game processing comprising:
when the first virtual object and the third virtual object are in a first positional relationship, executing second processing in which one of the first virtual object and the third virtual object exerts a first action on the other.

17. The one or more non-transitory computer-readable storage media according to claim 13, the game processing comprising:
moving a fourth virtual object, within a second range from the first virtual object, based on the first mouse sensor data.

18. The one or more non-transitory computer-readable storage media according to claim 17, wherein
the first controller has the first stick, and a first set of plural buttons or direction input buttons, at a front part, and has the first mouse sensor at a side part,
the second controller has the second stick, and a second set of plural buttons or direction input buttons, at a front part, and has the second mouse sensor at a side part,
in the first controller, the first stick is located upward of the first set of plural buttons or direction input buttons, and
in the second controller, the second set of plural buttons or direction input buttons is located upward of the second stick.

19. The one or more non-transitory computer-readable storage media according to claim 17, the game processing comprising:
when a third virtual object and one of the second virtual object or the fourth virtual object are in a first positional relationship, causing the one of the second virtual object or the fourth virtual object to retain the third virtual object; and
when the one and the other of the second virtual object or the fourth virtual object are in a first positional relationship or when the third virtual object and the other of the second virtual object or the fourth virtual object are in a first positional relationship, executing processing of exerting a first action on the third virtual object.

20. The one or more non-transitory computer-readable storage media according to claim 13, the game processing comprising:
moving the second virtual object, at a certain height, based on the second mouse sensor data; and
changing a height of the second virtual object, based on the second stick data or button operation data which is based on an operation on a first button provided to the second controller.
